(19) United States
(12) Patent Application Publication
(10) Pub. No.: US 2022/0012244 A1
(43) Pub. Date: Jan. 13, 2022

(54) ANTICIPATING QUERIES FOR INTERACTIVE METRICS BASED ON USAGE

(71) Applicant: ELECTRONIC ARTS INC., Redwood City, CA (US)

(72) Inventors: Serena Wang, Redwood City, CA (US); Kaiyu Liu, Redwood City, CA (US); Yu Jin, Fremont, CA (US); Sundeep Narravula, Saratoga, CA (US); Harold Chaput, Belmont, CA (US); Navid Aghdaie, San Jose, CA (US); Kazi Zaman, Foster City, CA (US)

(73) Assignee: ELECTRONIC ARTS INC., Redwood City, CA (US)

(21) Appl. No.: 16/925,055

(22) Filed: Jul. 9, 2020

(51) Int. Cl. G06F 16/2455; G06F 16/2453; G06F 16/25; G06F 16/248; G06Q 30/02

(52) U.S. Cl. CPC G06F 16/24552; G06F 16/24568; G06Q 30/02; G06F 16/254; G06F 16/248; G06F 16/24539

(57) ABSTRACT

A videogame metrics query system, and related method, has one or more databases and a speculative cache. The system stores videogame metrics and tracks queries relating to videogame metrics. The system generates multiple queries, based on a received query and tracked queries. The system generates a combined query that has greater computational efficiency of execution. From executing the combined query, the system extracts query results relevant to the received query, and caches remaining results in the speculative cache.

### BACKGROUND

Search engines, query engines and related technology are deployed on networks, including the Internet, worldwide. Various industries may have query needs, some of which are met by existing technology and some of which are not. The videogame industry has customers, developers, designers, marketing people and other users with diverse interests in queries, not all of which are served by the existing search engines and query engines technology. Therefore, there is a need in the art for a solution that improves on search engine and query engine technology, for example in efficiency and information access to videogame metrics.

### SUMMARY

In at least one embodiment, a processor-based method of anticipating queries for interactive videogame metrics comprises storing videogame metrics in a database, and tracking queries relating to the videogame metrics. The queries are tracked in the database or a further database. The method comprises receiving a first query relating to the videogame metrics, and generating multiple queries based on the first query and the tracked queries. The method comprises generating a second query that combines aspects of the first query and the multiple queries. The second query has greater computational efficiency of execution in comparison to execution of the multiple queries, and provides query results relevant to the first query. The method comprises executing the second query. The method comprises extracting the query results relevant to the first query, from results of executing the second query. The method comprises caching, in a speculative cache, remaining results of executing the second query.

In at least one embodiment, a tangible, non-transitory, computer-readable media has instructions recorded thereon. The instructions, when executed by a processor, cause the processor to perform various actions. The actions can include storing videogame metrics in one or more databases. The actions can include tracking, in the one or more databases, queries relating to the videogame metrics. The actions can include receiving a first query relating to the videogame metrics. The actions can include generating a plurality of queries based on the first query and the track queries. The actions can include generating a second query that combines aspects of the first query and the plurality of queries. The second query has greater computational efficiency of execution in comparison to execution of the plurality of queries. The second query provides query results relevant to the first query. The actions can include executing the second query. The actions can include extracting the query results relevant to the first query, from results of the executing the second query. The actions can include caching, in a speculative cache, remaining results of the executing the second query.

In at least one embodiment, a videogame metrics query system comprises a memory and one or more processors. The memory is to hold one or more databases and a speculative cache. The one or more processors are to store videogame metrics in the one or more databases in the memory. The one or more processors are to track, in the one or more databases in the memory, queries relating to the videogame metrics. The one or more processors are to receive a first query relating to the videogame metrics. The one or more processors are to generate a plurality of queries based on the first query and the tracked queries. The one or more processors are to generate a combined second query that combines aspects of the first query and the plurality of queries. The combined second query has greater computational efficiency of execution in comparison to execution of the plurality of queries. The combined second query provides query results relevant to the first query and the plurality of queries. The one or more processors are to execute the combined second query. The one or more processors are to extract the query results relevant to the first query, from results of executing the combined second query. The one or more processors are to cache, in the speculative cache in the memory, remaining results from the executing the second query.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 depicts an embodiment of a videogame metrics query system that has a query engine, databases and a speculative cache, and can generate a direct query result and speculative caching result(s).

FIG. 2 depicts an example of cost-effective speculative caching of game metrics, which can be performed by the videogame metrics query system of FIG. 1 and variations thereof.

FIG. 3 depicts an example of a first type of relevant query generation, in which the videogame metrics query system generates multiple queries across videogame titles or videogame types, and combines the generated queries into one or alternatively multiple combined queries of metrics across videogame titles or types.

FIG. 4 depicts an example of a second type of relevant query generation, in which the videogame metrics query system generates multiple queries with a deep dive of metrics for a single videogame, and combines the generated queries into one or alternatively multiple combined queries of metrics for the single videogame.

FIG. 5 depicts a flow diagram of a processor-based method of anticipating queries for interactive videogame metrics, which can be practiced by embodiments of the videogame metrics query system, or one or more processors and a memory that holds databases and a speculative cache.

FIG. 6 depicts example system components in an embodiment of the videogame metrics query system of FIG. 1.

FIG. 7 depicts extraction of information from user questions (i.e., queries), in an embodiment.

### DETAILED DESCRIPTION

Users of a videogame metrics query system described herein send a query to the system, for videogame metrics, and receive a direct query result. The system also performs speculative caching of further videogame metrics, for later access by the same or another user in a further query. Improvements are seen in computational efficiency for query processing, compared to individual processing of multiple queries, and in access efficiency for the speculative cached videogame metrics.

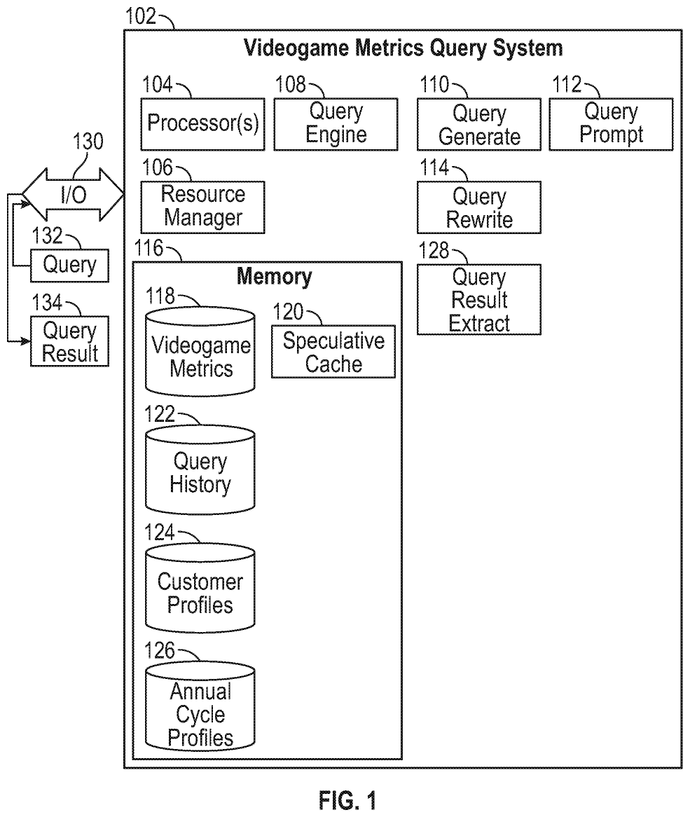

FIG. 1 depicts an embodiment of a videogame metrics query system 102 that has a query engine 108, databases 118, 122, 124, 126 and a speculative cache 120, and can generate a direct query result and speculative caching result(s). To communicate with the videogame metrics query system 102, a user (optionally with authentication) connects to and sends a query 132 through the I/O (input/output) connection 130, which could be a network connection, a port, etc., and receives a query result 134. Both the query 132 and the query result 134 relate to videogame metrics, of which examples are given below.

In the videogame metrics query system 102, one or more processors 104 work with various modules, which could be implemented as software executing on a processor, hardware, firmware, or various combinations thereof. The resource manager 106 manages resources for the other modules, such as arranging and allocating memory for databases 118, 122, 124, 126 and the speculative cache 120, allocating processors 104 or processor threads for the query engine 108 and other modules, managing communication channels and bandwidth, determining and assigning priority for processes, etc. In various embodiments, the videogame metrics query system 102 receives various metrics relating to video games, and stores the videogame metrics in a videogame metrics database 118, and/or generates videogame metrics and stores them in the videogame metrics database 118. For example, videogame metrics could include information about products, player numbers, player activities, the video game platform, game modes, comparisons of multiple titles, error metrics, revenue metrics, anomalies, game launch history, user attributes such as does a user have this game, is a user playing or not playing other games, does a user have add-on game packs, etc. Users or customers of the videogame metrics query system 102 could include analysts, game developers, triage personnel, product managers, program managers, marketing managers, employees of a videogame company, etc.

Upon receipt of a query 132, the query engine 108 and one or more of the remaining modules in the system become involved, and may perform various actions under various circumstances. Queries 132 are tracked in the query history database 122, i.e., the system writes information about each query into the query history database 122, for use in query generation and query rewrite. The system may determine to process the query 132, search for one or more videogame metrics relating to the query 132 in the videogame metrics database 118, and send out the findings in a query result 134. The query engine 108 may use various techniques and mechanisms including known search engines, query engines and related technology, with further techniques and mechanisms described herein, in various embodiments.

One feature of the various embodiments of the videogame metrics query system 102 is speculative caching. When this feature is active, the videogame metrics query system 102 receives a query 132, and uses the query generate module 110 to generate further queries, based on the received query 132 and the query history database 122, and possibly based on customer profiles in the customer profiles database 124 and/or annual cycle profiles in the annual cycle profiles database 126, about which more will be described below. For example, if the query 132 relates to a specific videogame title and one or more specific videogame metrics, the query generate module 110 could generate multiple queries relating to further video game titles, types of video games, versions or seasons of a videogame title, and/or further videogame metrics for the one videogame title or other videogame titles or types, according to previous queries recorded in the query history database 122. In one version, the system is attempting to predict what kinds of queries might be made in the future, based on what kinds of queries have been made in the past, and predictively generate those queries ahead of time.

After generating multiple queries, the query rewrite module 114 rewrites the original query 132 as a combination of the multiple queries, or equivalently generates a new query that combines the interests of the original query 132 and multiple queries. In some versions or under some circumstances, the query rewrite module 114 generates multiple combined queries. The query engine 108 processes the combined query (or multiple combined queries), searching in the videogame metrics database 118 for videogame metrics that satisfy the combined query or queries. Processing the combined query is more computationally efficient than processing each of multiple single queries and takes fewer passes through the videogame metrics database 118, less processing time and/or less processing resources in comparison. [QUESTION FOR EA: DO WE HAVE ANY DATA RELATED TO HOW MUCH FASTER/MORE EFFICIENT THE PERORMANCE IS?]

Taking results from processing the combined query, the query result extract module 128 extracts query results that are relevant to the original query 132, and provides the extracted query results in answer to the original query 132, i.e., answers the query 132 with the query result 134. The query result extract module 128 caches the remaining results from processing the combined query, or even all of the results in some versions, in the speculative cache 120. If at any time later (e.g., within a holding time for data in the speculative cache 120) a new query 132 arrives for which the system determines relevant results are in the speculative cache 120, the videogame metrics query system 102 retrieves from the speculative cache 120 and provides such results from the speculative cache 120 in answer to the new query 132.

At least one embodiment of the videogame metrics query system 102 has a query prompt module 112. When the query 132 is received and multiple queries are generated by the query generate module 110, the query prompt module 112 generates one or more query prompts, and sends a query prompt or multiple query prompts out to the user. A query prompt is intended (and generated and sent out by the system) to determine whether a user wants to access remaining results from processing the combined query, or perhaps other previous combined query results, in the speculative cache 120. For example, a query prompt could be, “did you also want videogame title, previous year or current year results?” or the like.

At least one embodiment of the videogame metrics query system 102 has a customer profiles database 124. The query generate module 110, the query rewrite module 114, or in a further embodiment a specialized customer profile module, develops customer profiles based on the tracked, past queries in the query history database 122. In order for this to be supported, the query history database 122 should record queries in association with customers. When the multiple queries are generated based on the arriving query 132, the query generate module 110 bases the multiple queries on both the received query 132 and the customer profile in the customer profiles database 124 that matches the customer making the query 132.

At least one embodiment of the videogame metrics query system 102 has an annual cycle profiles database 126. The query generate module 110, the rewrite module 114, or in a further embodiment a specialized annual cycle profile module, develops annual cycle profiles for annual cycles of querying, based on the tracked, past queries in the query history database 122. In order for this to be supported, the query history database 122 should record queries with timestamps or other indicator of year and time during the year (e.g., date, month, quarter, etc.) When the multiple queries are generated based on the arriving query 132, the query generate module 110 bases the multiple queries on both the received query 132 and one or more of the annual cycle profiles in the annual cycle profiles database 126. For example, some types of queries for specific videogame metrics may be more common or popular at certain times of the year, such as just before or after the Christmas season, near major sporting events (e.g., for sports-related videogame titles or racing games), or during summer when school is out. One embodiment of the videogame metrics query system 102 anticipates query topics based on usage pattern for time of year, based on one or more annual cycles in the annual cycle profiles database 126.

In performing the above and further actions leading to query responses and speculative caching, in various embodiments, the videogame metrics query system 102 is leveraging at least two databases, the videogame metrics database 118 and the query history database 122, for more thorough and efficient query processing. Using the data that is speculatively cached, the videogame metrics query system 102 is also providing more rapid response to queries. And, by developing and using the customer profiles database 124 and/or annual cycle profiles database 126, in related embodiments, the videogame metrics query system 102 is providing query responses tailored to specifics of customers (i.e., users) and customer usage of videogame metrics.

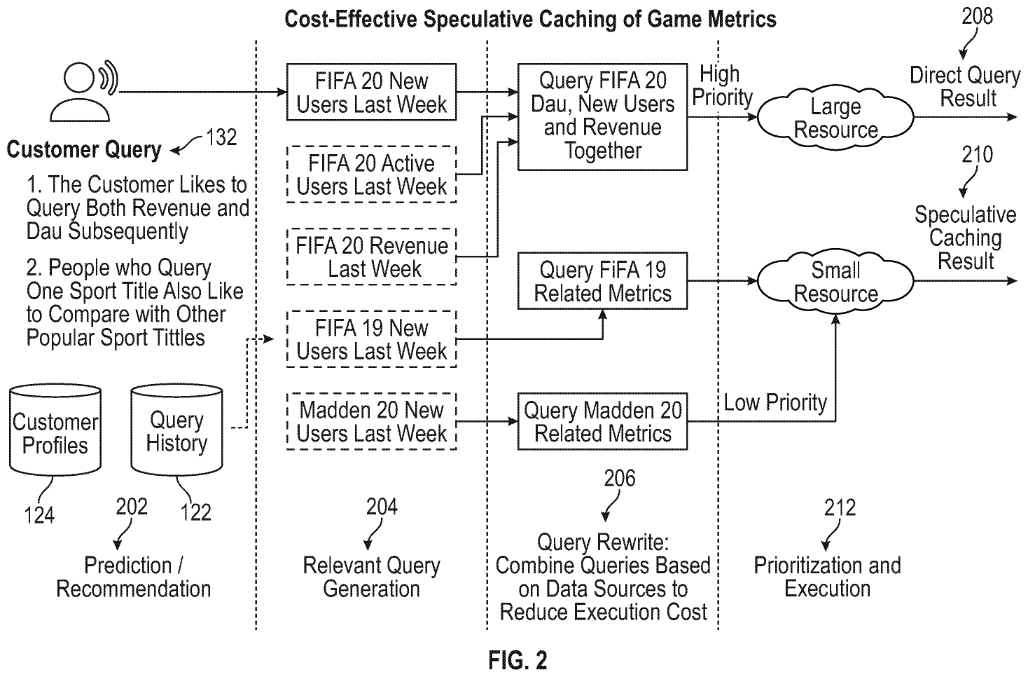

FIG. 2 depicts an example of cost-effective speculative caching of game metrics, which can be performed by the videogame metrics query system 102 of FIG. 1 and variations thereof. Generally, the videogame metrics query system 102 can receive a query relating to videogame metrics, for a single-game or single-game version (e.g., year or season), scan the database(s) and get multiple data types (e.g., new users, number of active users, revenue, etc.) In the example in FIG. 2, a customer sends a query 132 to the system, for a specific videogame title, season and videogame metric, e.g., FIFA 20 (the videogame title and season for the 2019 football or soccer season of Federation Internationale de Football Association) new users last week (the videogame metric). The system stores this query 132 (or aspects of this query) in the query history database 122, and updates the customer profiles database 124. By searching in the query history database 122 and/or the customer profiles database 124, the videogame metrics query system 102 determines, as query prediction and recommendation 202, 1. The customer likes to query both revenue and DAU (daily active users), and 2. People who query one sport title also like to compare with other popular sport titles.

Next, the videogame metrics query system 102 proceeds to relevant query generation 204, and generates the following queries: FIFA 20 new users last week (the original, received query 132), FIFA 20 active users last week (same title and season as in the query 132, different videogame metric), FIFA 20 revenue last week (same title and season, different videogame metric), FIFA 19 (2019, a different season for the FIFA title) new users last week (same videogame metric as in the query 132), and Madden 20 (a different title, for the 2020 football season with the Madden “brand” or franchise) new users last week (same videogame metric as in the original query 132).

After relevant query generation 204, the videogame metrics query system 102 proceeds to query rewrite 206, and combines queries based on data sources to reduce execution costs. The query rewrite 206 produces the following combined queries: Query FIFA 20 (same title and season as in the query 132) DAU (different videogame metric), new users (same videogame metric as in the query 132) and revenue together (different videogame metric), combining the original query 132 and the first and second uppermost generated queries in FIG. 2, Query FIFA 19 (different season/title) related metrics, and Query Madden 20 (different videogame title, same season as in the query 132) related metrics.

After query rewrite 206, the videogame metrics query system 102 proceeds to prioritization and execution 212, and executes or processes the rewritten, combined queries. The system assigns Large resource (e.g., faster, more powerful or higher numbers of processing resources) and High priority to the uppermost combined query that relates most closely to the original received query 132, and presents the query results, or extracts particular query results, for the direct query result 208. The system assigns Small resource (e.g., slower, less powerful, or lower numbers of processing resources) and Low priority to the other combined queries that relate less closely or do not relate directly to the original received query 132, and takes the query results or extracts particular query results as a speculative caching result 210. With reference to FIG. 1, this direct query result 208 is returned to the customer, as the query result 134 in answer to the query 132, and this speculative caching result 210 is written to the speculative cache 120.

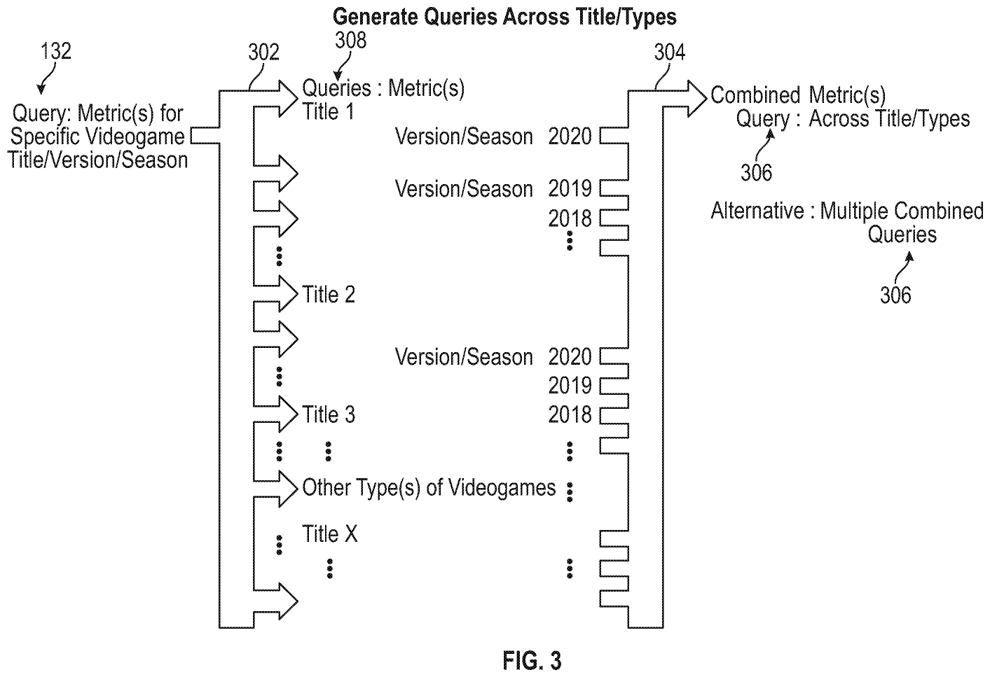

FIG. 3 depicts an example of a first type of relevant query generation, in which the videogame metrics query system 102 generates multiple queries 308 across videogame titles or videogame types, and combines the generated queries 308 into one combined query 306 or alternatively multiple combined queries 306 of metrics across videogame titles or types. For this type of relevant query generation, which may be termed cross-titles query generation, the query generate module 110 accesses the query history database 122 and determines what videogame titles, videogame versions, videogame seasons, videogame types, etc. have been queried in the past, for the same videogame metrics as the query 132 or alternatively for further videogame metrics. Using this information, query generate module 110 parses the received query 132, and produces variations on the received query 132 with the various videogame titles, versions, seasons, types, etc. as the multiple queries 308.

For example, referring back to FIG. 1, the videogame metrics query system 102 receives a query 132 for one or more specified videogame metrics, e.g., new users for the most recent week) for a specific videogame title, version or season, e.g., the videogame title and 2020 sports season FIFA 20. Query generate module 110 determines that users have also queried for the same videogame metric(s) about other videogame titles, versions, seasons, types, e.g., FIFA 19, and Madden 20, etc. In a variation, the query generate module 110 determines other videogame titles, versions, seasons, types, etc. that have had queries, even if of different videogame metrics than in the query 132. For both variations, the query generate module 110 then performs a generate action 302 (see FIG. 3) and generates multiple queries 308 for the videogame metrics specified in the received query 132 and the various videogame titles, versions, seasons, types, etc., e.g., a query for FIFA 19 new users most recent week, a query for Madden 20 new users most recent week, etc.

Next, the query rewrite module 114 performs a rewrite action 304 and rewrites the received query 132, or equivalently generates a new query, as the combined query 306. In this example, the combined query 306 for the metric(s) across titles or types is for new users for the most recent week (from the original received query 132) for multiple videogame titles, versions, seasons, types, etc., including Title 1-Title X or FIFA 20 (from the original received query 132), FIFA 19 and Madden 20 (from the generated queries 308 and see FIG. 2), etc. Alternatively, there could be multiple combined queries 306, for example for multiple videogame metrics.

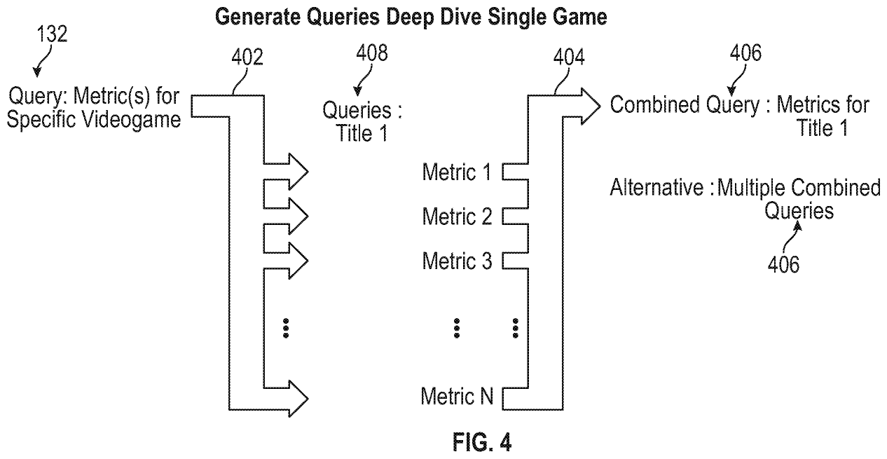

FIG. 4 depicts an example of a second type of relevant query generation, in which the videogame metrics query system 102 generates multiple queries 408 with a deep dive of metrics for a single videogame, and combines the generated queries 408 into one combined query 406 or alternatively multiple combined queries 406 of metrics for the single videogame. For this type of relevant query generation, which may be termed deep dive query generation, the query module 110 accesses the query history database 122 and determines what videogame metrics have been queried in the past, for the single videogame specified in the received query 132. Alternatively, the query module 110 determines what videogame metrics have been queried in the past for various videogame titles. Using this information, the query generate module 110 parses the received query 132, and produces variations on the received query 132 with the specified videogame title, version, season, type, etc., and various videogame metrics.

For example, referring back to FIG. 1, the videogame metrics query system 102 receives a query for one or more specified videogame metrics, e.g., new users for the most recent week for a specific videogame title, version or season, e.g. FIFA 20. Query generate module 110 determines that users have also queried for other videogame metrics, e.g., active users for the most recent week, revenue for the most recent week, new, active users or revenue for previous weeks, months, the entire year or other time spans, etc. In a variation, the query generate module 110 determines other videogame metrics that have had queries, even if of a different videogame title, version or season than in the query 132. For both variations, the query generate module 110 then performs a generate action 402 (see FIG. 4) and generates multiple queries 408 for the videogame title, version or season specified in the received query 132 and the various videogame metrics, e.g., new users, active users for the most recent week, revenue for the most recent week, other time spans, breakdown by platform, countries, etc.

Next, the query rewrite module 114 performs a rewrite action 404 and rewrites the received query 132, or equivalently generates a new query, as the combined query 406. In this example, the combined query 406 for the deep dive of metrics for a single videogame is for, e.g., Metric 1-Metric N or new users from the most recent week (from the original received query 132 and see FIG. 2), active users for the most recent week, revenue for the most recent week, new, active users and/or revenue for previous weeks, months, the year or other time spans, etc. (from the generated queries 408), for the videogame title, version and season, e.g., Title 1 or FIFA 20 (from the original received query 132 and see FIG. 2). Alternatively, there could be multiple combined queries 406, for example with groups of videogame metrics, or for other videogame titles, versions or seasons, etc.

Referring back to FIG. 2, a variation is for the videogame metrics query system 102 to combine aspects of the types of relevant query generation depicted and described with reference to FIGS. 3 and 4. For example, FIG. 2 depicts an example where the query generate module 110 produces queries for both different videogame titles and seasons, and multiple videogame metrics that were not specified in the original received query 132. FIG. 2 further depicts an example where the query rewrite module 114 produces multiple combined queries 406, including one combined query 406 for the specified videogame title from the original received query 132, FIFA 20 and multiple videogame metrics, e.g., new users and revenue, another combined query 406 for a different videogame season, FIFA 19 and multiple videogame metrics, and yet another combined query 406 for another videogame title, Madden 20 and related videogame metrics. Further variations on these actions and mechanisms are readily devised in keeping with the teachings herein.

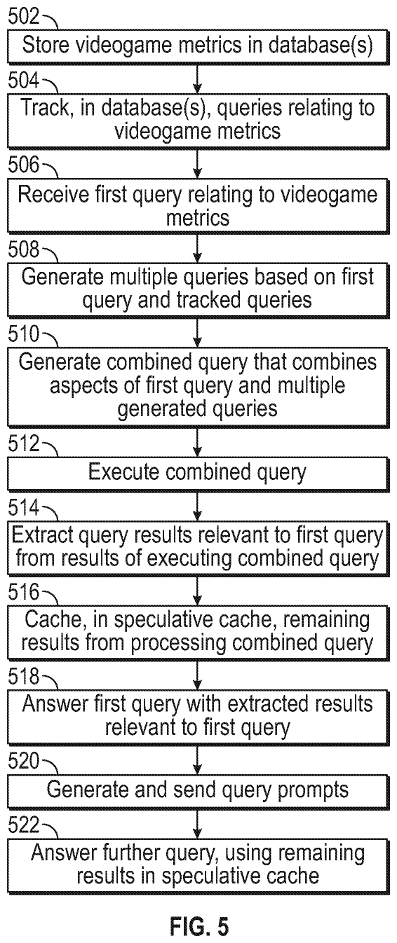

FIG. 5 depicts a flow diagram of a processor-based method of anticipating queries for interactive videogame metrics, which can be practiced by embodiments of the videogame metrics query system, or one or more processors and a memory that holds databases and a speculative cache. Alternatively, the method may be termed a cost-effective speculative caching of game metrics.

In an action 502, the system stores videogame metrics in one or more databases. For example, the system could store videogame metrics in a videogame metrics database.

In an action 504, the system tracks, in the database(s), queries relating to videogame metrics. For example, the system could track queries in a query history database. The system could track queries in association with customers, in the query history database.

In an action 506, the system receives a first query relating to videogame metrics. The query may specify a videogame title and one or more videogame metrics.

In an action 508, the system generates multiple queries based on the first query and the tracked queries. To do so, the system is accessing and leveraging the videogame metrics and the tracked queries, for example in the videogame metrics database and the query history database, and possibly also in the customer profiles database and/or the annual cycle profiles database, in various embodiments.

In an action 510, the system generates a combined query that combines aspects of the first query and multiple generated queries. The system generates more than one combined query, in some embodiments.

In an action 512, the system executes the combined query. Executing (or processing) the combined query has greater computational efficiency in comparison to executing multiple individual queries. Executing the combined query provides query results relevant to the first query, and further query results.

In an action 514, the system extracts query results relevant to the first query, from result of executing the combined query.

In an action 516, the system caches, in the speculative cache, the remaining results from processing the combined query. This may be termed a speculative caching result.

In an action 518, the system answers the first query with extracted results relevant to the first query. This may be termed a direct query result.

In an action 520, the system generates and sends one or more query prompts. The query prompts are generated to determine whether a user wants to access the remaining results of processing the combined query, in the speculative cache.

In an action 522, the system answers a further query, using remaining results in the speculative cache.

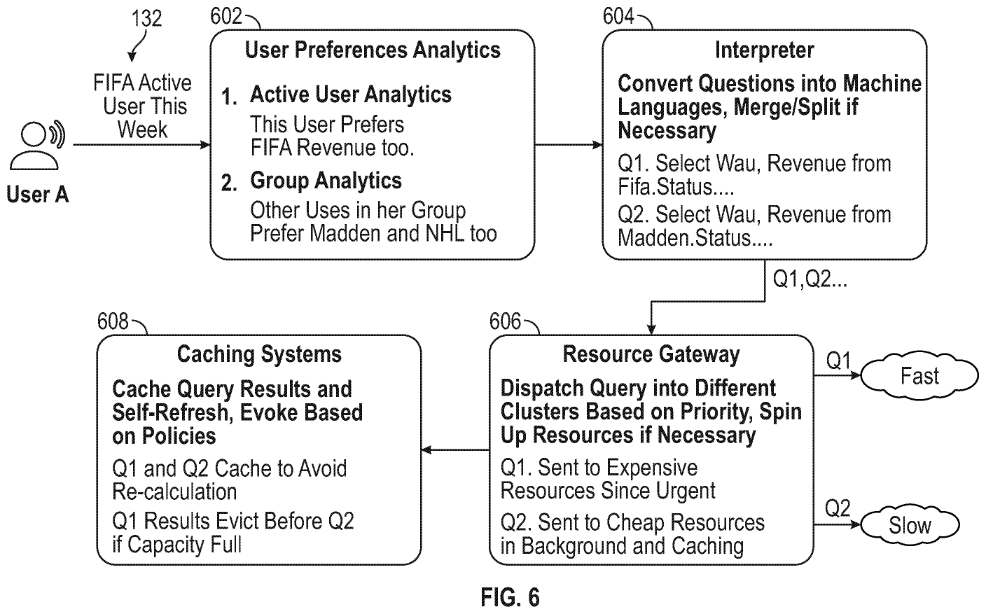

FIG. 6 depicts example system components in an embodiment of the videogame metrics query system 102 of FIG. 1. The system has a user preferences analytics (UPA) module 602, an interpreter 604, a resource gateway 606, and caching systems 608, each of which can be implemented in software executing on the processor(s) 104, hardware, firmware, or various combinations thereof in various embodiments. In the scenario depicted in FIG. 6, a user, e.g., User A sends a query 132 “FIFA active user(s) this week” to the system, which engages various components. The user preferences analytics module 602 determines 1. Through active user analytics, this user prefers FIFA revenue, also, and 2. Through group analytics, other users in a user group that includes User A prefer analytics for videogame titles Madden and NHL (National Hockey League), also. For example, the videogame metrics query system 102 accesses the query history database 122 and/or the customer profiles database 124 to make this determination.

Next, the interpreter 604 converts one or more questions into machine languages, performing a merge or split if necessary. In the example shown, the interpreter 604 produces a query Q1: select wau (weekly active users), revenue from fifa.status . . . , and a query Q2: select wau, revenue from madden.status . . . , and communicates or makes available these queries to the resource gateway 606. For example, the videogame metrics query system 102 uses the query generate module 110 and the query rewrite module 114 as described above, to generate multiple queries and one or more combined queries, in this case, the two queries Q1 and Q2.

The resource gateway 606 dispatches the query (or queries) into different clusters (or, more generally, various system resources, for example as assigned by the resource manager 106) based on priority, and spins up (i.e., activates, allocates) resources if necessary. In the example shown, Q1 is sent to expensive resources (e.g., labeled “Fast”) since urgent, and Q2 is sent to cheap resources (e.g., labeled “Slow”) in background and caching.

Caching systems 608 caches query results and self-refresh, which are evoked based on policies. In the example shown, there are two caches, a fast cache for results of processing Q1, and a slow cache (i.e., slower than the fast cache) for results of processing Q2. The Q1 and Q2 caches holds the cached query results to avoid re-calculation. In the embodiment shown, the Q1 results evict before Q2, if the capacity is full. Relating to FIG. 1, the videogame metrics query system 102 caches results of executing Q2 in the speculative cache 120 in memory 116.

With ongoing reference to FIG. 6, one embodiment of user preference analytics module 602 constantly analyzes and learns the historical records of the users, and builds up models to predict users' preference(s). For example, when one user from FIFA team asks (i.e., queries) “FIFA active user last week”, UPA 602 will provide the potential game metrics that this user may also like to know, such as “FIFA revenue last week”, as the first priority questions. All first priority questions are to be included in the response to the user, in some embodiments. In the meantime, UPA 602 also provides top-ranked questions from other users who asked similar questions, such as “NFL and Madden active user and revenue last week” for cross-game title comparison. These questions are low priority questions, which represent the potential curiosity of the user. All low priority questions results will be cached only, without sending to users unless asked in the future.

With ongoing reference to FIG. 6, one embodiment of the interpreter 604 translates users' questions (i.e., queries 132) in Natural Language into system languages that can be executed in the backend data processing system. One embodiment of the videogame metrics query system 102 uses Presto as the data processing engine, which contains rich types of connectors to integrate various data sources into one. Presto accepts ANSI SQL (American National Standards Institute structured query language) as its input, thus the interpreter 604 converts NLP (natural language processing) questions into ANSI SQL queries. For this purpose, the interpreter 604 is trained with NLP models specifically enhanced with pools of pre-defined fuzzy rules for metrics, dimensions, game titles, etc. Thus the sample question “FIFA active user last week” will be finally translated into “with tbl as (select dt,max(dau) as dau from cbm.daily_engagement_au_v2 where 1=1 and game_id=‘923002’ and dt>=‘2020-03-18’ group by dt order by dt asc) select dt,dau from tbl”.

With ongoing reference to FIG. 6, one embodiment of the resource gateway 606 controls the global workload and resource information of all the clusters. The resource gateway 606 is responsible for allocating resources for the queries and spin up of extra resource(s) if necessary. Referring back to FIG. 1, the resource gateway 606 could be an alternative embodiment of the resource manager 106, or could include the resource manager 106 or vice versa, in variations.

With ongoing reference to FIG. 6, the caching systems 608 store query results temporarily to provide fast response for duplicate requests. Such temporary storage is usually less expensive, computationally and with regard to resources, than using computing resources for duplicate requests.

In a previous example, two first priority queries, and one low priority query are created for the user after prediction and interpretation. These queries will be submitted to the resource gateway 606 to be scheduled for processing. The high priority queries (e.g., Q1) will be dispatched to powerful resources if possible for fast response, and low priority queries (e.g., Q2) will go to less powerful but cheap resources for processing and caching. In some embodiments, the high priority queries results can also be cached if retrieved by other users and/or the system deems this a likelihood.

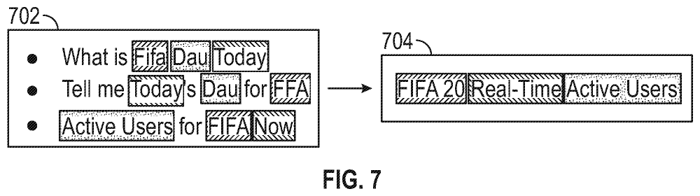

FIG. 7 depicts extraction of information from user questions (i.e., queries 132), in an embodiment. Examples of user questions 702 are, as depicted, “What is fifa dau today” (to be interpreted as a query for the daily active user count for today, for the videogame title FIFA without specifying the 2020 season), “Tell me today's dau for FFA” (to be similarly interpreted despite misspelling FIFA), and “Active users for FIFA now” (to be similarly interpreted, despite not specifying the 2020 season for this videogame title). As FIG. 7 shows, the challenges for extraction of information from user questions can include syntax free input, typos are common (especially with mobile input), and there are limited terms carrying useful information (e.g., game names, metrics, data ranges, etc.) One goal, or requirement for one embodiment, is for the system to support free-form of input. In this example, the extracted or determined query 704, from the syntax free input user questions 702, is “FIFA 20 real-time active users”. One embodiment uses information extraction with fuzzy regex matching for a solution.

With ongoing reference to FIG. 7, for one embodiment, for query translation and table match, a parser detects different components: game names, metrics, dimensions, date ranges, aggregate level, etc. A translator constructs SQL queries using the above components. With reference back to FIG. 1, one embodiment of the videogame metrics query system 102 uses the query engine 108 to search in the videogame metrics database 118 to find one or more appropriate tables with videogame metrics that are relevant to a query, i.e., table match. A query translation example is given below.

A user enters the query, “what is ffa dau today?” (misspelling FIFA, not providing the “20” for the 2020 season)
The system, for example an application running in the videogame metrics query system 102, replies back to the user with a natural language processing interpretation in the form of a question, prompt, or statement “I think you meant FIFA 20 real-time active users?”, and the information as a query reply or query result:

| Datetime | Active Users |
|---|---|
| 2020 Feb. 22 | 5.93M |
| 23:08:14.331 UTC | |

Behind the scenes, i.e., in processing internal to the videogame metrics query system 102, there is a Pond V2 query.

Variations on the above examples, for other programming languages, parameters, metrics, videogame titles, queries, etc., for various embodiments of the videogame metrics query system 102 are readily devised in keeping with the teachings herein. The term “computer-readable media” can include a single medium or multiple media that store instructions, and can include any mechanism that stores information in a form readable by a computer, such as read-only memory (ROM), random-access memory (RAM), erasable programmable memory (EPROM and EEPROM), or flash memory.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings and still be within the scope of the following claims. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A processor-based method of anticipating queries for interactive videogame metrics, comprising:
storing videogame metrics in a database;
tracking, in the database or a further database, queries relating to the videogame metrics;
receiving a first query relating to the videogame metrics;
generating a plurality of queries based on the first query and the tracked queries;
generating a second query that combines aspects of the first query and the plurality of queries, has greater computational efficiency of execution in comparison to execution of the plurality of queries and provides query results relevant to the first query;
executing the second query;
extracting the query results relevant to the first query, from results of the executing the second query; and
caching, in a speculative cache, remaining results of the executing the second query.

2. The processor-based method of anticipating queries for interactive videogame metrics of claim 1, further comprising:
providing the extracted query results relevant to the first query, in answer to the first query; and
providing at least a portion of the remaining results of the executing the second query, from the speculative cache, in answer to a third query.

3. The processor-based method of anticipating queries for interactive videogame metrics of claim 1, further comprising:
generating one or more query prompts in response to the receiving the first query, to determine whether a user wants to access the remaining results of the executing the second query, in the speculative cache.

4. The processor-based method of anticipating queries for interactive videogame metrics of claim 1, further comprising:
developing a customer profile of querying, for each of one or more customers, based on the tracking the queries, wherein the tracking the queries comprises tracking customers in association with the queries, and wherein the generating the plurality of queries based on the first query and the tracked queries is further based on the customer profile.

5. The processor-based method of anticipating queries for interactive videogame metrics of claim 1, wherein the second query is of a first type of combined query for one or more types of the videogame metrics across a plurality of videogame titles or a plurality of videogame types.

6. The processor-based method of anticipating queries for interactive videogame metrics of claim 1, wherein the second query is of a second type of combined query for a videogame with multiple types of the videogame metrics for the videogame.

7. The processor-based method of anticipating queries for interactive videogame metrics of claim 1, further comprising:
developing a profile of an annual cycle of querying, to anticipate query topics based on a usage pattern, based on the tracking the queries, wherein the generating the plurality of queries based on the first query and the tracked queries is further based on the profile of the annual cycle of querying.

8. A tangible, non-transitory, computer-readable media having instructions thereupon which, when executed by a processor, cause the processor to perform:
storing videogame metrics in one or more databases;
tracking, in the one or more databases, queries relating to the videogame metrics;
receiving a first query relating to the videogame metrics;
generating a plurality of queries based on the first query and the tracked queries;
generating a second query that combines aspects of the first query and the plurality of queries, has greater computational efficiency of execution in comparison to execution of the plurality of queries and provides query results relevant to the first query;
executing the second query;
extracting the query results relevant to the first query, from results of the executing the second query; and
caching, in a speculative cache, remaining results of the executing the second query.

9. The computer-readable media of claim 8, wherein the instructions further cause the processor to perform:
answering the first query, using the extracted query results relevant to the first query; and
answering a third query, using remaining results in the speculative cache.

10. The computer-readable media of claim 8, wherein the instructions further cause the processor to perform:
generating one or more query prompts in response to the receiving the first query, to determine whether a user wants to access the remaining results of the executing the second query, in the speculative cache.

11. The computer-readable media of claim 8, wherein the instructions further cause the processor to perform:
developing a customer profile of querying, for each of one or more customers, in a customer profile database, based on the tracking the queries, wherein the tracking the queries comprises tracking customers in association with the queries, and wherein the generating the plurality of queries based on the first query and the tracked queries is further based on the customer profile.

12. The computer-readable media of claim 8, wherein the second query is of a first type of combined query for one or more types of the videogame metrics across a plurality of videogame titles or a plurality of videogame types.

13. The computer-readable media of claim 8, wherein the second query is of a second type of combined query for a single game that is a deep dive of the first query with breakdown by multiple types of the videogame metrics for the single game.

14. The computer-readable media of claim 8, wherein the instructions further cause the processor to perform:
developing a profile of an annual cycle of querying, in an annual cycle profiles database to anticipate query topics based on a usage pattern, based on the tracking the queries, wherein the generating the plurality of queries based on the first query and the tracked queries is further based on the profile of the annual cycle of querying.

15. A videogame metrics query system, comprising:
a memory, to hold one or more databases and a speculative cache; and
one or more processors, to:
store videogame metrics in the one or more databases in the memory;
track, in the one or more databases in the memory, queries relating to the videogame metrics;
receive a first query relating to the videogame metrics;
generate a plurality of queries based on the first query and the tracked queries;
generate a combined second query that combines aspects of the first query and the plurality of queries, has greater computational efficiency of execution in comparison to execution of the plurality of queries and provides query results relevant to the first query and the plurality of queries;
execute the combined second query;
extract the query results relevant to the first query, from results of executing the combined second query; and
cache, in the speculative cache in the memory, remaining results from the executing the combined second query.

16. The videogame metrics query system of claim 15, wherein the one or more processors are further to:
answer the first query with the extracted query results relevant to the first query; and
answer a third query using at least a portion of the remaining results of the executing the second query, from the speculative cache.

17. The videogame metrics query system of claim 15, wherein the one or more processors are further to:
prompt a user with one or more query prompts in response to the receiving the first query, to offer access to the remaining results of the executing the second query, in the speculative cache.

18. The videogame metrics query system of claim 15, wherein the one or more processors are further to:
develop a customer profile of querying, for each of one or more customers, and the one or more databases, based on the tracked queries, wherein to track the queries comprises to track customers in association with the queries, and wherein to generate the plurality of queries based on the first query and the tracked queries is further based on the customer profile.

19. The videogame metrics query system of claim 15, wherein the combined second query is of a first type of combined query for one or more types of the videogame metrics across a plurality of videogame titles or a plurality of videogame types, or the combined second query is of a second type of combined query for a single game that is a deep dive of an existing query with breakdown by multiple types of the videogame metrics for the single game.

20. The videogame metrics query system of claim 15, wherein the one or more processors are further to:
develop a profile of an annual cycle of querying, in the one or more databases, to anticipate query topics based on a usage pattern, based on the tracked queries, wherein to generate the plurality of queries based on the first query and the tracked queries is further based on the profile of the annual cycle of querying.

21. The videogame metrics query system of claim 15, wherein the one or more processors are further to:
rank the tracked queries, in a query history database, as to a first priority for first videogame metrics that are to be included in a primary response to a query, and a second priority for second videogame metrics that are to be cached in the speculative cache.

22. The videogame metrics query system of claim 15, wherein the one or more processors are further to:
support free-form of input for queries; and
use information extraction with fuzzy matching for interpreting the queries.

23. The videogame metrics query system of claim 15, wherein the one or more processors are further to:
reply to a user, in response to the first query, with a natural language processing interpretation of the first query in form of a question, prompt or statement.
